(19) United States
(12) Patent Application Publication
(10) Pub. No.: US 2024/0202598 A1
(43) Pub. Date: Jun. 20, 2024

(54) SEMI-AUTOMATED LABELING OF TIME-SERIES SENSOR DATA

(71) Applicant: QEEXO, CO., San Jose, CA (US)

(72) Inventors: Stephanie Pavlick, Pittsburgh, PA (US); Elias Lee Fallon, Allison Park, PA (US); William Isaac Levine, Pittsburgh, PA (US); Hasan Smeir, Pittsburg, PA (US)

(73) Assignee: QEEXO, CO., San Jose, CA (US)

(21) Appl. No.: 18/541,134

(22) Filed: Dec. 15, 2023

Related U.S. Application Data
(60) Provisional application No. 63/387,901, filed on Dec. 16, 2022.

(51) Int. Cl. G06N 20/00

(52) U.S. Cl. CPC G06N 20/00

(57) ABSTRACT

A method for semi-automated labeling of data for machine learning training. Data is collected via time-series sensors to form an unlabeled dataset. After receiving one or more event type labels for a subset of the dataset, thereby forming a labeled dataset, the remainder of the unlabeled dataset is automatically labeled. Potential new labels for the remainder of the unlabeled dataset are determined via cross correlation between the labeled dataset and unlabeled dataset. The potential new labels are presented as training data for a machine learning algorithm.

### CROSS-REFERENCE TO RELATED APPLICATIONS

This application claims priority to Provisional U.S. Patent Application No. 63/387,901, titled “Semi-Automated Labeling of Time-Series Sensor Data,” filed on Dec. 16, 2022, by Stephanie Pavlick et al., which is incorporated herein by reference in its entirety and for all purposes.

### TECHNICAL FIELD

The present disclosure relates generally to machine learning algorithms, and more specifically to enhancement of machine learning model datasets.

### BACKGROUND

Systems have attempted to use various machine learning (ML) models and computer learning algorithms for various purposes. Building machine learning models requires training examples. These training examples usually consist of input data that is similar to the input data the ML model will see in production usage. Often, labels which demonstrate the output expected from the ML model for given inputs are necessary for proper training. However, existing methods for labeling large datasets are normally manual processes and are extremely time consuming. Thus, there is a need for an improved method for automatic labeling of large datasets in order to provide high-quality training data with inputs and labels which are valuable to the final product.

### SUMMARY

The following presents a simplified summary of the disclosure in order to provide a basic understanding of certain embodiments of the present disclosure. This summary is not an extensive overview of the disclosure and it does not identify key/critical elements of the present disclosure or delineate the scope of the present disclosure. Its sole purpose is to present some concepts disclosed herein in a simplified form as a prelude to the more detailed description that is presented later.

In general, certain embodiments of the present disclosure provide techniques or mechanisms, systems, and non-transitory computer readable media for semi-automated labeling of datasets. In one aspect, a method for semi-automated labeling of datasets is provided. The method comprises collecting data via one or more time-series sensors to form an unlabeled dataset corresponding to raw sensor data. The method also includes receiving one or more event type labels for a subset of the unlabeled dataset thereby forming a labeled dataset. The method also includes generating a new convolved dataset by convolving the labeled dataset with the unlabeled dataset corresponding to the raw sensor data. Next, the method also includes automatically determining potential new labels for any unlabeled segments remaining in the unlabeled dataset via cross correlation between the labeled dataset and the unlabeled dataset. Last, the method includes presenting the new labelled data as training data and/or testing data for a machine learning algorithm.

In some embodiments, the time-series sensors include one or more of the following: accelerometers, gyroscopes, magnetometers, thermometers, pressure sensors, ultrasonic time-of-flight sensors, humidity sensors, and microphones. In some embodiments, the dataset includes one or more recorded events of interest. In some embodiments, determining the potential new labels includes determining whether the one or more event type labels is an event label or a background label. In some embodiments, determining the potential new labels includes summing cross correlation results across all sensor data streams in the dataset. In some embodiments, determining the potential new labels includes collapsing all raw data in the dataset into one dimension. In some embodiments, determining the potential new labels includes identifying candidate potential new labels using multiple peak identification in a given segment.

These and other embodiments are described further below with reference to the figures.

### BRIEF DESCRIPTION OF THE DRAWINGS

The disclosure may best be understood by reference to the following description taken in conjunction with the accompanying drawings, which illustrate particular embodiments of the present disclosure.

FIG. 1 illustrates a high level dataflow diagram, in accordance with one or more embodiments.

FIGS. 2A-2B illustrate a process flow diagram for semi-automated labeling of datasets, in accordance with one or more embodiments.

FIGS. 3A-3C illustrate a graphical representation of an example time-series accelerometer data across 3 axes, in accordance with one or more embodiments.

FIG. 4 illustrates one example of a computer system that can be used in conjunction with the techniques and mechanisms of the present disclosure, in accordance with one or more embodiments.

### DETAILED DESCRIPTION OF PARTICULAR EMBODIMENTS

Reference will now be made in detail to some specific examples of the present disclosure including the best modes contemplated by the inventors for carrying out the present disclosure. Examples of these specific embodiments are illustrated in the accompanying drawings. While the present disclosure is described in conjunction with these specific embodiments, it will be understood that it is not intended to limit the present disclosure to the described embodiments. On the contrary, it is intended to cover alternatives, modifications, and equivalents as may be included within the spirit and scope of the present disclosure as defined by the appended claims.

For example, the techniques of the present disclosure will be described in the context of particular algorithms. However, it should be noted that the techniques of the present disclosure apply to various other algorithms. In the following description, numerous specific details are set forth in order to provide a thorough understanding of the present disclosure. Particular example embodiments of the present disclosure may be implemented without some or all of these specific details. In other instances, well known process operations have not been described in detail in order not to unnecessarily obscure the present disclosure.

Various techniques and mechanisms of the present disclosure will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present disclosure unless otherwise noted. Furthermore, the techniques and mechanisms of the present disclosure will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

In current technology, sensors can collect large volumes of data. The data can be very useful in analyzing and identifying event occurrences and operational states for various systems. However, the large volumes of data are usually in the form of raw data, which is meaningless unless the data can be sorted, organized, and/or labeled. As mentioned above, labeling of data is generally a manual process that is inefficient, costly, and impractical for large amounts of data. According to current technology, automated or assisted labeling for data has been researched in academia and industry for almost as long as machine learning. However, most approaches have focused on image, video, or text data. More specifically, there are currently no effective techniques for automatic labeling of large volumes of sensor data. The techniques and mechanisms of the present disclosure provide for a supervised machine learning technique to transform raw sensor data into labeled sensor data that can be used to inform users of event occurrences pertaining to various event classes in particular systems of interest.

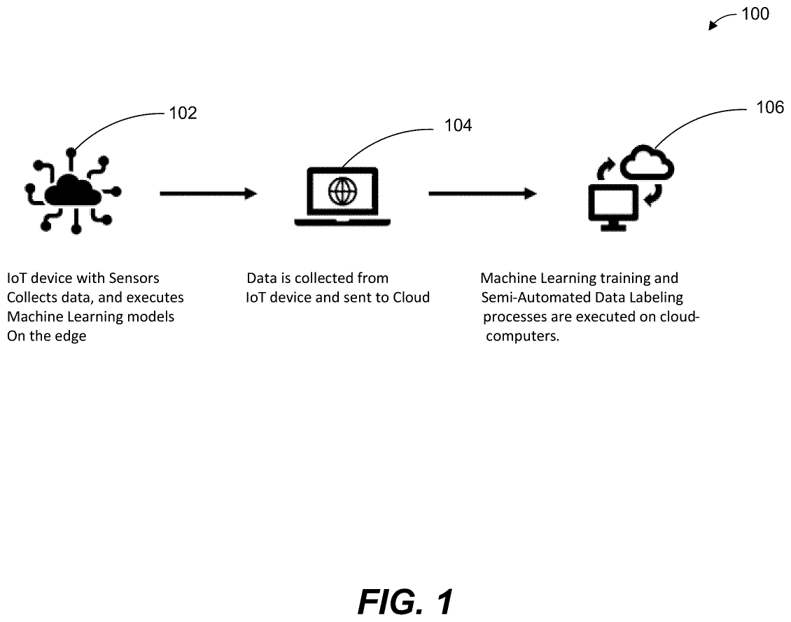

FIG. 1 illustrates a high level dataflow diagram, in accordance with one or more embodiments. Dataflow 100 illustrates how data is collected and processed according some embodiments. In some embodiments, data is collected 102 from time-series sensors. In some embodiments, time-series sensors are internet of things (IOT) devices, such as accelerometers, gyroscopes, magnetometers, thermometers, pressure (atmospheric and force) sensors, ultrasonic time-of-flight sensors, humidity sensors, or microphones. In some embodiments, any sensor data which can be decomposed to time-series format, encompassing time, typically in sub-second intervals, on the x-axis and a numeric value on the y-axis, can be utilized for the techniques and mechanisms of the present disclosure. In some embodiments, in a given data recording, a set of events of interest are recorded a number of times. In some embodiments, the data collected from IoT devices are sent 104 to the cloud. Then, machine learning training and semi-automated data labeling process are executed 106 on cloud computers.

According to various embodiments, a user labels the first (or the first few) instances of the events of interest with a label for each event type. The user then requests the system, or a software application running on the system, to assist in labeling the remainder of the data recording, or potentially other data recordings. The system takes the labeled examples and finds the best matches in the unlabeled data recording and suggests those as potential new labels. The user can then accept or reject each recommendation in a supervised learning methodology, thereby improving their productivity.

In some embodiments, the system employs a complex process to provide suggested new labels for time-series sensor data. At a high-level, after receiving labeled data, the system then determines if the input label is an “event” type label, or a “background” label. In some embodiments, an “event” type label corresponds to significant signal changes in the labeled data range. For example, in a system that utilizes sensors to monitor the operational states or analyze the functionality of an elevator door, event type labels may include labels such as “OPEN” or “CLOSE.” These “OPEN” or “CLOSE” event labels correspond to two types of real-world event classes: a physical sliding door opening and the physical sliding door closing. In some embodiments, event classes can include many other types of activities. For example, in a system that uses sensors to monitor a conveyor belt, event type classes can include “loading” and “unloading” of bins onto and off of the conveyor belt. Another example could be a machine running at defined speeds or being idle. Alternately, the event classes can also represent other activities in completely different systems. For example, one such system could be an accelerometer (the sensor) worn by a person in order to detect the occurrence of certain activities, such as jumping, doing push-ups, or other types of physical activity.

In some embodiments, “background” type labels are labels that signify that not much is going on in the target environment. In some embodiments, background labels may not even be necessary, since “events” are actively identified. However, in some embodiments, background type labels are utilized to identify baseline states, such as sleeping, sitting, walking, etc. It should be noted that in some embodiments, depending on the monitoring goals, an operation state like “walking” can be either a background label (for example in a system configured to monitor the amount of times a user trips while walking) or an event label (for example in a system configured to monitor any type of physical activity from a resting position), depending on the particular context of the monitoring system. In some embodiments, background labels can include labels such as “REST,” where the target machine or environment is not moving or is at rest or is idle. In some embodiments, what differentiates an event type label from a background type label is activity above, in the case of an event, or below, in the case of a background, a certain threshold.

According to various embodiments, the sensors collect data continuously, regardless of whether or not an event, such as a door closing (for elevator), occurs. In some embodiments, because the machine learning system is supervised, a user needs to first label the data to identify events. Thus, in some embodiments, label data becomes input for machine learning training (as correct output labels). The machine learning process then takes the input data and trains itself with those output labels. In some embodiments, labeling data involves taking raw data (sensor values) and correlating the raw data with a marked time range, which results in a label for training the machine learning model. In some embodiments, the initial labeling can be implemented by indicating which time ranges on the time series data correspond to different event type events, e.g., when a door opens, when the door is still, or when the door closes. In some embodiments, each label has different information depending on the event type.

As an example, for a particular data sample to be labeled, the sensors may have recorded 1000 of the door opening, closing, and pause cycles. If the user needs to click and drag a label over each time range of interest, this can become very time consuming and tedious. Instead, if the user need only to label an initial 10 of these particular events, then these initial labeled data can then be used to train a machine learning algorithm to automatically label the remainder of the data.

In some embodiments, for each event-type label, the system then uses cross correlation from the labeled event raw signal with the unlabeled raw signal on each independent sensor data stream and axis, thereby generating an entirely new signal. The cross correlation effectively creates a mathematical representation of when the labeled signal most closely matches the target signal. If there are multiple labeled events provided as examples, the system then performs this cross correlation for each provided labeled event. The cross correlation results are then summed across all sensor data streams and axes and each input labeled event. Next, the system finds the peaks in the resulting cross correlation sum, and then uses a Frobenius normalization of the signal to calculate the time-span ranges of the event around the peaks. In some embodiments, this results in an identified timestamp, and/or a time duration, of when a particular event has occurred. In other words, the system creates new segments with the original time series data that match up with identified timestamps indicated by peaks in the cross correlation. In some embodiments, the cross correlation results in a new signal with exaggerated peaks to aid in event identification. In some embodiments, Frobenius normalization is used to find the relative scale of the signals without being dependent on absolute magnitude. In some embodiments, other normalization techniques can be used in order to introduce a level of insensitivity to absolute magnitude between different data recordings. In some embodiments, these normalized time ranges are then provided to the user as the recommended additional labels. In some embodiments, for each background-type label, the system finds the regions with less activity than the threshold of “event activity” and proposes them as the background-type label.

In some embodiments, the cross correlation process involves convolving a labeled signal with the raw version of the signal. In some embodiments, a cross correlation module takes the segment that was user-labeled, convolves that segment across the entire signal (thereby giving a displacement and multiplying the signals with each other). In some embodiments, as the segment is slid across the entire raw signal, a matching pattern may appear. When a pattern matches up approximately (not necessarily exactly), peaks and valleys in the signal will be multiplied and summed, and thus emphasized, resulting in emphasized (increased) values for easier identification. By finding matching patterns, cross correlation will identify events that are similar in duration and also contain matching signal frequencies. In some embodiments, a Frobenius normalization will be applied to the resulting dot product to ensure signals with similar amplitudes are identified as matching signals. In some embodiments, “sliding” the segment involves adding a time offset to the segment in order to search for a matching pattern. In some embodiments, that time segment will have an array of values, or multiple discrete values. In some embodiments, each discrete value will be multiplied against a different part of the signal. Thus, in some embodiments, the entire signal is decomposed into discrete numbers. In such embodiments, the discrete values in the labeled segment are then multiplied against the discrete numbers representing a different piece of the raw signal. If the dot products of the multiplication for a particular segment of the signal have a large enough value, the algorithm will identify the particular segment as a matching pattern. In some embodiments, a threshold value number for that identification is pre-determined using a threshold algorithm, such as the Otsu threshold algorithm. In some embodiments, the Otsu threshold algorithm looks at a range of data that results from the convolution of the labeled and raw signals. In such embodiments, the Otsu threshold algorithm then searches for a midpoint that lets the algorithm decide what constitutes high activity/values and what constitutes low activity/values on a given signal. Because thresholding in terms of machine learning is generally used for image processing, where binary boundary identification is easily applicable, thresholding is not normally used for event classification for raw sensor data, due to the fact that aberrations in the signal can mean many things, such as noise, a change in a state, or normal fluctuations due to a constant cyclical state of motion. However, the techniques and mechanisms of the present disclosure are able to effectively utilize thresholding in the context of event classification of raw sensor data because of the novel utilization of convolving labeled signals with their corresponding raw data signal across multiple sensor axes.

Another use case for the techniques and mechanisms of the present disclosure is the identification of different fault cases. In the elevator example, a company might be interested in identifying various different elevator faults because different faults require different service resolutions. In such cases, the raw collected data is then labeled with different types of faults, e.g., scraping fault, obstruction in the track, roller damage, etc.

Although the examples provided above include sensor data from an elevator system, according to various embodiments, sensor data from various other systems can also be utilized. In some embodiments, data from a wearable device can be transformed into labeled data that indicates whether a user is running, walking, doing jumping jacks, etc. In such embodiments, the method would first involve identifying a change of state. Next, the method would look at the relative magnitudes of the signal and identify the dominant frequencies. Once the system has calibrated for data in a certain state, e.g., walking, the accelerometer data may show a change in state based on a change in dominant frequencies. For example, the state of walking may have a dominant frequency of 10 hz, while the state of running may have a dominant frequency of 30 hz. In such an example, if the machine learning algorithm then sees another unlabeled segment that is one continuous activity, the system can identify the dominant frequency and determine if the user is walking or running. Thus, in some embodiments, the system may retrieve segments of labeled data pertaining to certain states and then use those labeled data segments in a certain state to convolve with a raw data signal in order to automatically label a state, such as walking, by matching the dominant frequency of walking. In some embodiments, the system can also incorporate a clustering technique in order to further examine the signal. In such embodiments, a user may first identify segments of each type of activity and train a clustering algorithm on features calculated from the labeled stretches of activity. In some embodiments, unlabeled stretches of activity can be labeled by extracting features from the raw signal data then passing the feature values through the previously trained clustering algorithm to identify the cluster to which the data matches most closely.

With machine learning, there is a paradigm shift from focusing on the model itself to improving the data that is feeding into the model in order to improve the machine learning operation. The techniques and mechanisms of the present disclosure provide an improvement to the functioning of a computer itself because the techniques and mechanisms reduce machine learning training time and increase accuracy and efficiency of machine learning operation. Because training and operation of machine learning models usually require intense processing time and power from graphical processing units, reducing training time and increasing training accuracy can directly lead to faster and more efficient of processing of computer systems themselves.

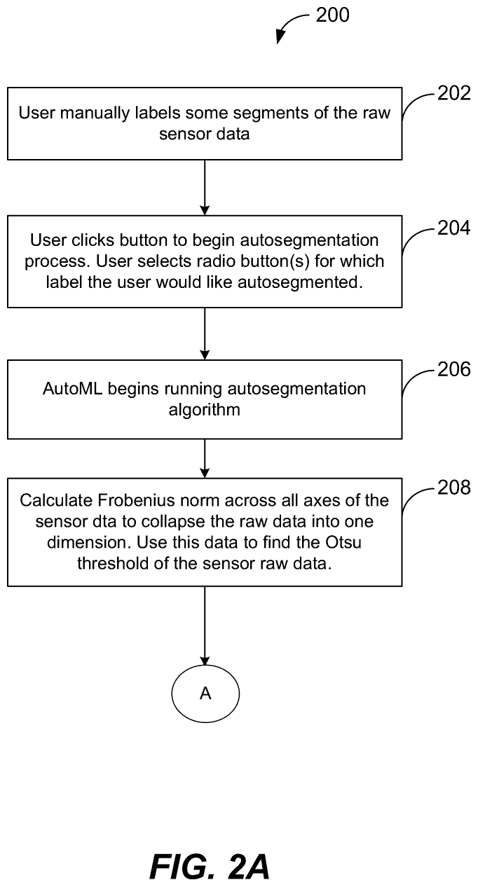

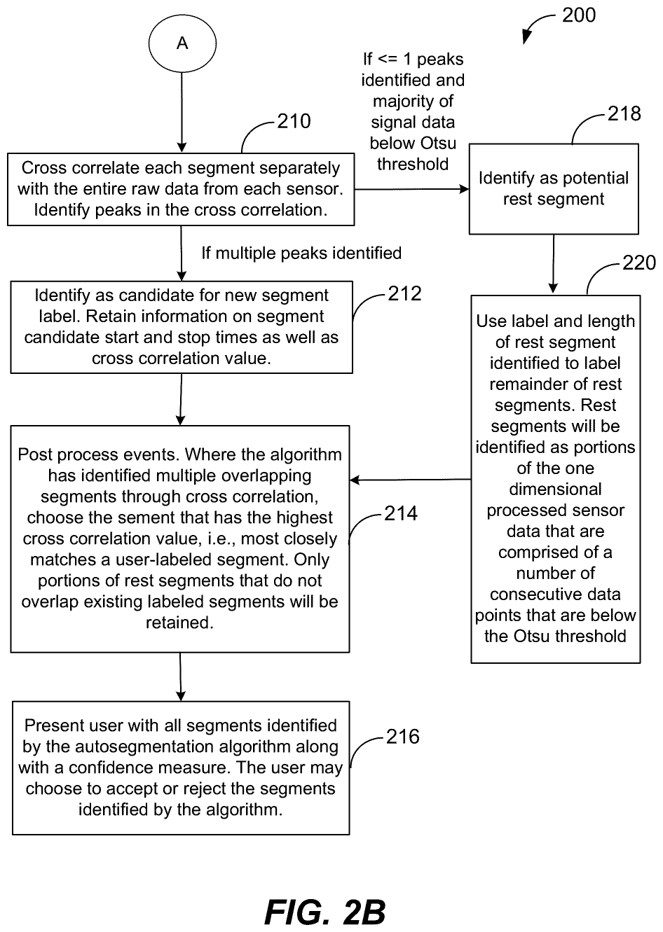

FIGS. 2A-2B illustrate a more detailed process flow diagram for a method 200 of semi-automated labeling of datasets, according to some embodiments. At step 202, a user manually labels some segments of the raw sensor data. At 204, the user clicks a button to begin an autosegmentation process. In some embodiments, the user selects radio button(s) for which label the user would like autosegmented. At 206, the system begins running the autosegmentation algorithm. At 208, the system calculates a Frobenius norm across all axes of the sensor data to collapse the raw data into one dimension. In some embodiments, the system uses this data to find the Otsu threshold of the sensor raw data. In some embodiments, the algorithm will examine all discrete raw data values collected to determine a threshold, known as the Otsu threshold, to separate all raw data into two classes and to minimize the variance between the raw values in each class. In some embodiments, the Otsu threshold is used to find a mid-point in the values of the data to define a threshold to distinguish between low activity and high activity. In some embodiments, other thresholding methods can be used to define a threshold, but empirical data has suggested that the Otsu threshold method results in the highest performance in this application. At step 210, the system cross correlates each segment separately with the entire raw data from each sensor. In some embodiments, the system also identifies peaks in the cross correlation. If the system only identifies 1 peak or less, and the majority of the signal data is below an Otsu threshold, then the method proceeds to step 218. If the system identifies multiple peaks, then the method proceeds to step 212.

At step 212, the system identifies the identified multiple peaks segments as candidates for new segment labeling. In some embodiments, the system also retains information on segment candidate start and stop times as well as cross correlation values. At step 214, the system post processes events. In some embodiments, if the algorithm has identified multiple overlapping segments through cross correlation, the system chooses the segment that has the highest cross correlation value, i.e., the segment that most closely matches a user-labeled segment. In some embodiments, only portions of rest segments that do not overlap existing labeled segments will be retained. At step 216, the system then presents the user with all segments identified by the autosegmentation algorithm along with a confidence measure. In some embodiments, the user may choose to accept or reject the segments identified by the algorithm.

If the system only identifies 1 peak or less, and the majority of signal data is below an Otsu threshold, then the method proceeds to step 218. At step 218, the system identifies the segment with 1 peak or less as a potential rest segment. At step 220, the system uses the label and length of the rest segment identified to label the remainder of the rest of the segments. In some embodiments, the rest segments will be identified as a portion of the one dimensional processed sensor data that are comprised of a number of consecutive data points that are below the Otsu threshold.

Overall, this process has found sensor signal events from the unlabeled data that closely resemble the similar labeled data provided by the user, and then proposed those new events to the user as additional potential labeled events. The process previously described enables the techniques and mechanisms of the present disclosure to work across multiple sensor streams of time-series sensor data and multiple data-types and labels.

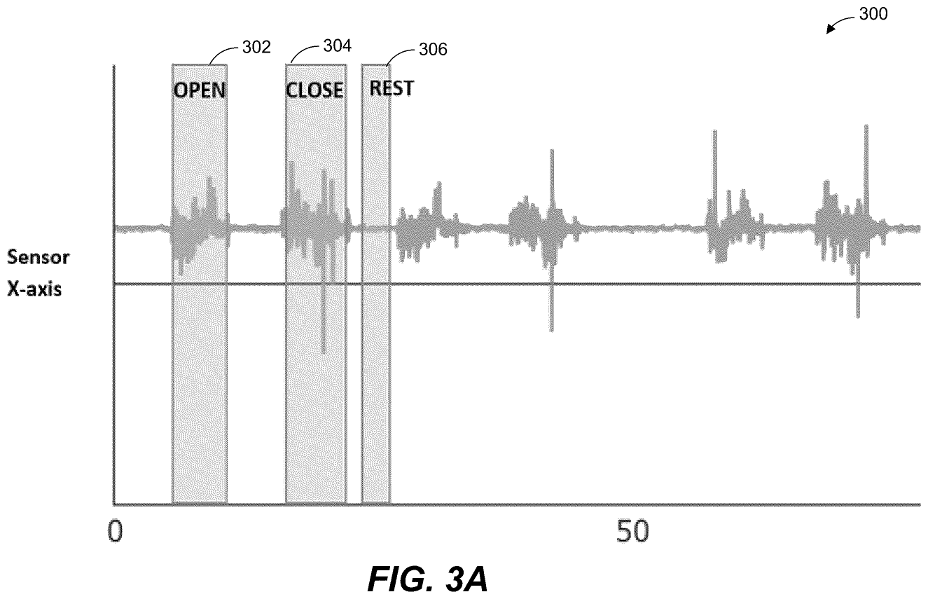

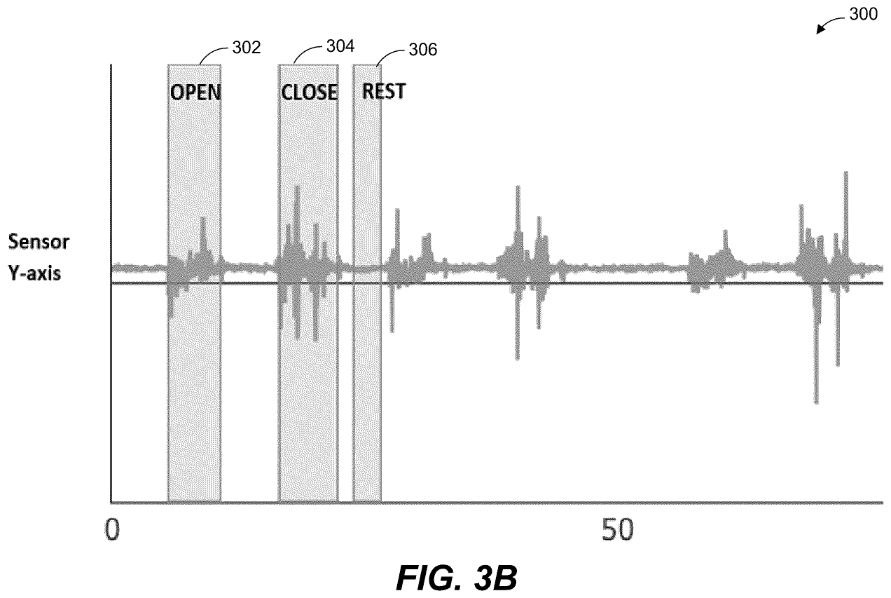

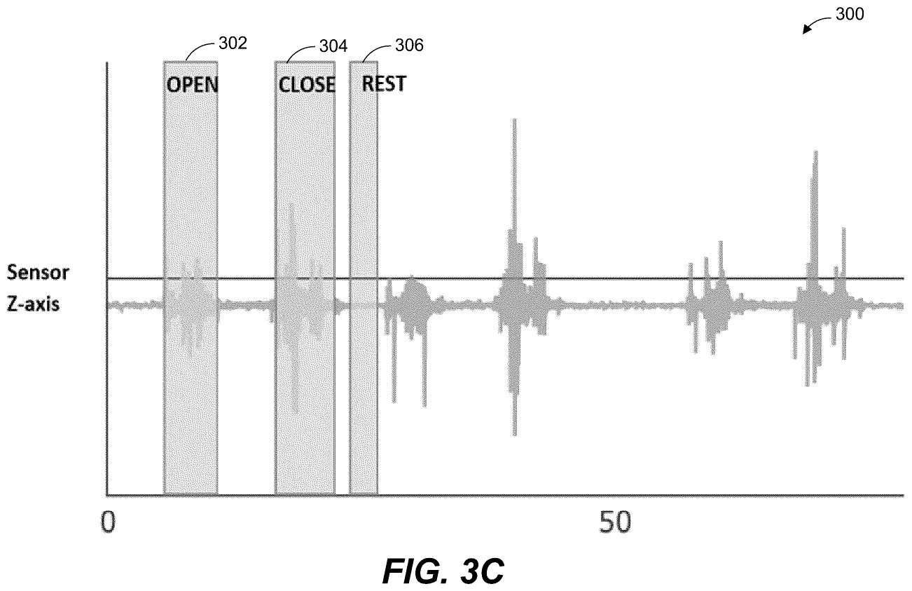

FIGS. 3A-3C illustrate a graphical representation of an example time-series accelerometer data, split into three component axes of motion: X, Y, and Z, in accordance with one or more embodiments. Graph 300 illustrates three different labels. One label 302 is an “event” type label called “OPEN,” identifying the portion of data collected while an elevator door was opening. Label 304 is another event type label called “CLOSE,” identifying the portion of data collected while an elevator door was closing. Label 306 is a “background” type label called “REST.” This portion of the signal consists of data collected while the elevator doors were either fully closed or fully opened, i.e. not actively in motion. The example time-series data shows motion sensor (accelerometer) data from a motion sensor attached to an automatic sliding door. For that problem, the events of interest are when the door opens or closes or is just sitting still. These provide the three labels: “OPEN,” “CLOSE,” and “REST.” The user could use any set of events that are of interest. For example, one set of events can be environmental sensors (such as temperature+humidity sensors placed in a kitchen) detecting when an oven door or refrigerator door is opened. In another example, one set of events can be motion sensors (such as accelerometer and gyroscope) on a person's wrist detecting when they raise their wrist to look at a watch. In some embodiments, each of these events will have a distinct sensor pattern and set of labels the system user will want to apply. According to various embodiments, the techniques and mechanisms of the present disclosure can help assist the user in creating those labels in these example situations and many others.

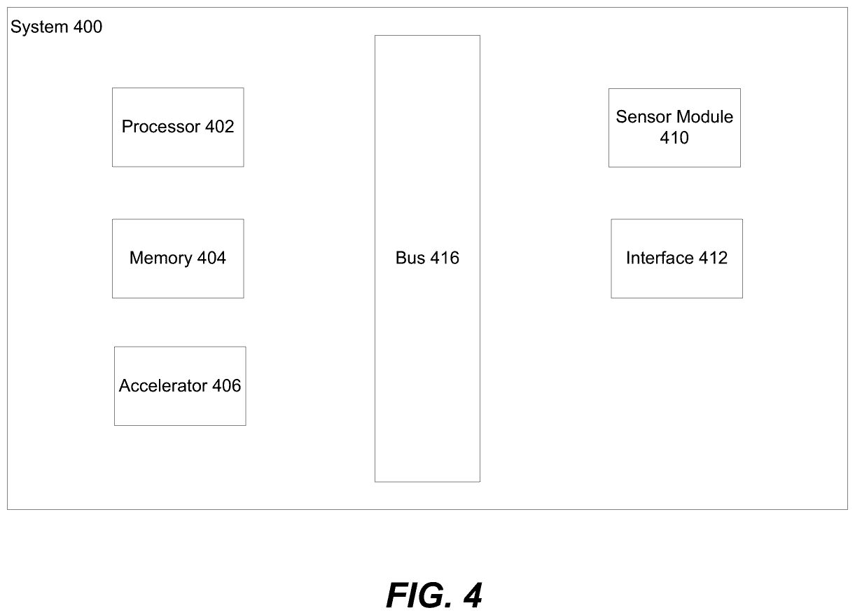

FIG. 4 illustrates one example of a computer system 400, in accordance with one or more embodiments. According to particular embodiments, a system 400, suitable for implementing particular embodiments of the present disclosure, includes a processor 402, a memory 404, accelerator 406, sensor module 410, an interface 412, and a bus 416 (e.g., a PCI bus or other interconnection fabric). In some embodiments, system 400 operates as a streaming server. In some embodiments, when acting under the control of appropriate software or firmware, processor 402 is responsible for various processes, including processing inputs through various computational layers and algorithms. Various specially configured devices can also be used in place of a processor 402 or in addition to processor 402. The interface 412 is typically configured to send and receive data packets or data segments over a network.

Particular examples of interfaces supports include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management.

According to particular example embodiments, system 400 uses memory 404 to store data and program instructions for operations including labeling datasets. The program instructions may control the operation of an operating system and/or one or more applications, for example. The memory or memories may also be configured to store received metadata and batch requested metadata.

In some embodiments, system 400 further comprises a sensor module 410 configured for collecting and gathering data from different sensors. Such sensor module 410 may be used in conjunction with accelerator 406. In various embodiments, accelerator 406 is a processing accelerator chip. The core of accelerator 406 architecture may be a hybrid design employing fixed-function units where the operations are very well defined and programmable units where flexibility is needed. Accelerator 406 may also include of a binning subsystem and a fragment shader targeted specifically at high level language support. In various embodiments, accelerator 406 may be configured to accommodate higher performance and extensions in APIs, particularly OpenGL 2 and DX9.

Because such information and program instructions may be employed to implement the systems/methods described herein, the present disclosure relates to tangible, or non-transitory, machine readable media that include program instructions, state information, etc. for performing various operations described herein. Examples of machine-readable media include hard disks, floppy disks, magnetic tape, optical media such as CD-ROM disks and DVDs; magneto-optical media such as optical disks, and hardware devices that are specially configured to store and perform program instructions, such as read-only memory devices (ROM) and programmable read-only memory devices (PROMs). Examples of program instructions include both machine code, such as produced by a compiler, and files containing higher level code that may be executed by the computer using an interpreter.

While the present disclosure has been particularly shown and described with reference to specific embodiments thereof, it will be understood by those skilled in the art that changes in the form and details of the disclosed embodiments may be made without departing from the spirit or scope of the present disclosure. It is therefore intended that the present disclosure be interpreted to include all variations and equivalents that fall within the true spirit and scope of the present disclosure. Although many of the components and processes are described above in the singular for convenience, it will be appreciated by one of skill in the art that multiple components and repeated processes can also be used to practice the techniques of the present disclosure.

What is claimed is:

1. A method for semi-automated labeling of datasets, the method comprising:
collecting data via one or more time-series sensors to form an unlabeled dataset corresponding to raw sensor data;
receiving one or more event type labels for a subset of the unlabeled dataset thereby forming a labeled dataset;
generating a new convolved dataset by convolving the labeled dataset with the unlabeled dataset corresponding to the raw sensor data;
automatically determining potential new labels for any unlabeled segments remaining in the unlabeled dataset via cross correlation between the labeled dataset and the unlabeled dataset; and
presenting the new labelled data as training data and/or testing data for a machine learning algorithm.

2. The method of claim 1, wherein the time-series sensors include one or more of the following: accelerometers, gyroscopes, magnetometers, thermometers, pressure sensors, ultrasonic time-of-flight sensors, humidity sensors, and microphones.

3. The method of claim 1, wherein the dataset includes one or more recorded events of interest.

4. The method of claim 1, wherein determining the potential new labels includes determining whether the one or more event type labels is an event label or a background label.

5. The method of claim 1, wherein determining the potential new labels includes summing cross correlation results across all sensor data streams in the dataset.

6. The method of claim 1, wherein determining the potential new labels includes collapsing all raw data in the dataset into one dimension.

7. The method of claim 1, wherein determining the potential new labels includes identifying candidate potential new labels using multiple peak identification in a given segment.

8. A system for semi-automated labeling of datasets, the system comprising:
one or more time-series sensors;
a processor; and
memory, the memory storing instructions for executing a method, the method comprising:
collecting data via one or more time-series sensors to form an unlabeled dataset corresponding to raw sensor data;
receiving one or more event type labels for a subset of the unlabeled dataset thereby forming a labeled dataset;
generating a new convolved dataset by convolving the labeled dataset with the unlabeled dataset corresponding to the raw sensor data;
automatically determining potential new labels for any unlabeled segments remaining in the unlabeled dataset via cross correlation between the labeled dataset and the unlabeled dataset; and
presenting the potential new labels as training data for a machine learning algorithm.

9. The system of claim 8, wherein the time-series sensors include one or more of the following: accelerometers, gyroscopes, magnetometers, thermometers, pressure sensors, ultrasonic time-of-flight sensors, humidity sensors, and microphones.

10. The system of claim 8, wherein the dataset includes one or more recorded events of interest.

11. The system of claim 8, wherein determining the potential new labels includes determining whether the one or more event type labels is an event label or a background label.

12. The system of claim 8, wherein determining the potential new labels includes summing cross correlation results across all sensor data streams in the dataset.

13. The system of claim 8, wherein determining the potential new labels includes collapsing all raw data in the dataset into one dimension.

14. The system of claim 8, wherein determining the potential new labels includes identifying candidate potential new labels using multiple peak identification in a given segment.

15. A non-transitory computer readable storage medium storing one or more programs configured for execution by a computer, the one or more programs comprising instructions for:
collecting data via one or more time-series sensors to form an unlabeled dataset corresponding to raw sensor data;
receiving one or more event type labels for a subset of the unlabeled dataset thereby forming a labeled dataset;
generating a new convolved dataset by convolving the labeled dataset with the unlabeled dataset corresponding to the raw sensor data;
automatically determining potential new labels for any unlabeled segments remaining in the unlabeled dataset via cross correlation between the labeled dataset and the unlabeled dataset; and
presenting the potential new labels as training data for a machine learning algorithm.

16. The non-transitory computer readable medium of claim 15, wherein the time-series sensors include one or more of the following: accelerometers, gyroscopes, magnetometers, thermometers, pressure sensors, ultrasonic time-of-flight sensors, humidity sensors, and microphones.

17. The non-transitory computer readable medium of claim 15, wherein the dataset includes one or more recorded events of interest.

18. The non-transitory computer readable medium of claim 15, wherein determining the potential new labels includes determining whether the one or more event type labels is an event label or a background label.

19. The non-transitory computer readable medium of claim 15, wherein determining the potential new labels includes summing cross correlation results across all sensor data streams in the dataset.

20. The non-transitory computer readable medium of claim 15, wherein determining the potential new labels includes collapsing all raw data in the dataset into one dimension.
